(19) United States
(12) Patent Application Publication
(10) Pub. No.: US 2005/0279802 A1
(43) Pub. Date: Dec. 22, 2005

(54) Seal for portable fastener driving tool

(76) Inventor: Larry M. Moeller, Mundelein, IL (US)

Correspondence Address: Lisa M. Soltis;Illinois Tool Works Inc., 3600 West Lake Avenue, Glenview, IL, 60025, US

(21) Appl. No.: 10/932,900

(22) Filed: Sep. 2, 2004

Related U.S. Application Data
(63) Continuation-in-part of application No. 10/866,974, filed on Jun. 14, 2004, now abandoned.

(51) Int. Cl. B25C 1/08

(52) U.S. Cl. 227/130

(57) ABSTRACT

A seal for use in a fastener-driving tool on a component moving relative to another component, includes a component body defining at least one seal groove, a metallic ring disposed in the at least one seal groove, and a polymeric ring disposed in the at least one seal groove in operational relationship to the metallic ring.

### RELATED APPLICATION

This application is a Continuation-In-Part of U.S. Ser. No. 10/866,974 filed Jun. 14, 2004.

### BACKGROUND

The present invention relates generally to fastener-driving tools used to drive fasteners into workpieces, and specifically to combustion-powered fastener-driving tools, also referred to as combustion tools.

Combustion-powered tools are known in the art, and one type of such tools, also known as IMPULSE® brand tools for use in driving fasteners into workpieces, is described in commonly assigned patents to Nikolich U.S. Pat. Re. No. 32,452, and U.S. Pat. Nos. 4,522,162; 4,483,473; 4,483,474; 4,403,722; 5,197,646; 5,263,439 and 6,145,724, all of which are incorporated by reference herein. Similar combustion-powered nail and staple driving tools are available commercially from ITW-Paslode of Vernon Hills, Ill. under the IMPULSE® and PASLODE® brands.

Such tools incorporate a generally pistol-shaped tool housing enclosing a small internal combustion engine. The engine is powered by a canister of pressurized fuel gas, also called a fuel cell. A battery-powered electronic power distribution unit produces a spark for ignition, and a fan located in a combustion chamber provides for both an efficient combustion within the chamber, while facilitating processes ancillary to the combustion operation of the device. Such ancillary processes include: inserting the fuel into the combustion chamber; mixing the fuel and air within the chamber; and removing, or scavenging, combustion by-products. The engine includes a reciprocating piston with an elongated, rigid driver blade disposed within a single cylinder body.

A valve sleeve is axially reciprocable about the cylinder and, through a linkage, moves to close the combustion chamber when a work contact element at the end of the linkage is pressed against a workpiece. This pressing action also triggers a fuel-metering valve to introduce a specified volume of fuel into the closed combustion chamber.

Upon the pulling of a trigger switch, which causes the spark to ignite a charge of gas in the combustion chamber of the engine, the combined piston and driver blade is forced downward to impact a positioned fastener and drive it into the workpiece. The piston then returns to its original, or pre-firing position, through differential gas pressures within the cylinder. Fasteners are fed magazine-style into the nosepiece, where they are held in a properly positioned orientation for receiving the impact of the driver blade.

Fastener-driving tools of the types described above typically require seals for the reciprocating piston and the valve sleeve to prevent gas leakage, and lubrication to reduce friction between sliding components such as the piston and the cylinder, as well as the valve sleeve and the cylinder head. Conventional metallic piston rings require lubrication to reduce friction and to prevent wear on aluminum cylinders and other combustion chamber components. It is well known that lack of suitable lubrication causes premature wear and possibly operational failure. Lubrication is applied at assembly and following each maintenance period. Supplemental lubrication is supplied with each dose of fuel into the combustion chamber, since the fuel cartridges are provided with lubricant mixed with the fuel.

Since the combustion engine is not hermetically sealed, and air must periodically enter the combustion chamber, dirt eventually infiltrates into the tool, even when filters are provided and potential leak areas provided with dust seals. Conventional fastener-driving tools require periodic maintenance for removing accumulated deposits of oil, dirt, combustion by-products and heat-affected deposits. Despite the fact that conventional metallic piston rings perform a scraping/cleaning function on internal cylinder walls, periodic maintenance is still required with extended tool use. Among other things, the frequency of cleaning is a function of the frequency and/or rate of operation, and environmental conditions of tool use.

Often the operator does not maintain the tool until failure occurs. At such times, extensive cleaning of the tool is required. Many operators consider such maintenance as a tool failure, since the tool is unavailable for use. While preventive maintenance is the key to avoiding cleaning-related downtime, it is not often practiced.

One goal of fastener-driving tool manufacturers is to eliminate such maintenance operations. Since a primary ingredient for the accumulation of such deposits is the lubrication oil, reduction or elimination of the oil should reduce the buildup of dirt and deposits. Some manufacturers have employed polymeric seals for reducing oil. However, in many cases, conventional seals are relatively short-lived, in the range of 50,000 operational cycles (combustion events). As the cycle total exceeds that amount, seal function is reduced and wear increases.

Another problem of conventional polymeric seals is that exhaust gas blow-by occurs at joints and at seal surface imperfections of noncontiguous seals. Due to high temperatures and corrosive compounds in the exhaust gas, such blow-by shortens operational life for such seals. However, when solid or continuous O-rings or other polymeric seals are employed, installation difficulties result such as incorrect seating and seal stretching. Further, it has been found that in some cases elastomeric seals such as O-rings become damaged upon exposure to exhaust valves in the cylinder. Still another drawback of O-rings and other such reduced lubrication seals is that the O-rings require compression to properly seat. With increased tool temperatures, it has been found in many cases that polymeric seals expand to the point of causing binding of the moving components. Providing a joint in the polymeric seal improves installation and allows for thermal expansion, but introduces a leakage path for blow-by. As such, polymeric seals have not been suitable for use in combustion chambers of combustion-type fastener-driving tools.

Thus, there is a need for a seal for a fastener-driving tool which requires reduced lubricant or no lubricant. There is also a need for a reduced lubricant seal which prevents exhaust blow-by. Another need is for a reduced lubrication seal which is less susceptible to damage from internal tool components and/or the stressful combustion environment.

### BRIEF SUMMARY OF THE INVENTION

Accordingly, the above-identified needs are met or exceeded by the present seal for a fastener-driving tool. By providing a combination of a metallic seal and a polymeric seal, the need for lubrication is reduced, while increasing the operational life compared to conventional purely polymeric seals. Also, such a seal combination is more durable in stressful combustion environments.

More specifically, the present invention provides a seal for use in a fastener-driving tool on a component moving relative to another component, includes a component body defining at least one seal groove, a metallic ring disposed in the at least one seal groove, and a polymeric ring disposed in the at least one seal groove in operational relationship to the metallic ring.

In another embodiment, a seal for use in a fastener-driving tool with at least one exhaust valve on a component moving relative to another component, includes a component body defining at least one seal groove having a body key formation. A polymeric ring with a joint for improved assembly is configured for disposition in the at least one seal groove and has a ring key formation configured for engaging the body key formation, such that upon installation in the at least one groove, the joint is free of operational contact with the at least one exhaust valve.

### BRIEF DESCRIPTION OF THE SEVERAL VIEWS OF THE DRAWINGS

FIG. 1 is a fragmentary vertical section of a fastener-driving tool suitable for use with the present seal;

FIG. 2 is an exploded perspective view of the present seal used on a piston;

FIG. 3 is a fragmentary vertical section of the seal shown in FIG. 2 shown assembled;

FIG. 4 is a fragmentary vertical section of an alternate embodiment of the seal of FIG. 3;

FIG. 5 is a fragmentary vertical section of a second alternate embodiment of the seal of FIG. 3;

FIG. 6 is a fragmentary vertical section of a third alternate embodiment of the seal of FIG. 3;

FIG. 7 is a fragmentary vertical section of a fourth alternate embodiment of the seal of FIG. 3; and

FIG. 8 is a fragmentary vertical section of a fifth alternate embodiment of the seal of FIG. 3.

### DETAILED DESCRIPTION OF THE INVENTION

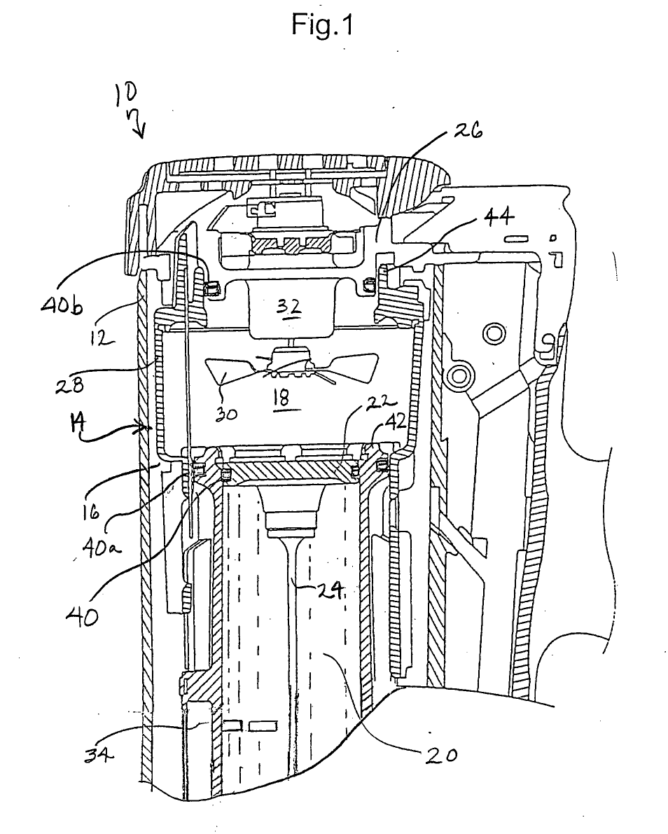

Referring now to FIG. 1, a fastener-driving tool of the type suitable for use with the present seal is generally designated 10 and is shown as a combustion-powered tool, however it is contemplated that the present seal is suitable for use with pneumatic, electric or other types of tools having reciprocating components such as pistons and/or valve sleeves. The tool 10 is preferably of the general type described in detail in the patents listed above and incorporated by reference in the present application. A housing 12 of the tool 10 encloses a self-contained internal power source 14, preferably within a housing main chamber 16, but other configurations are contemplated. As in conventional combustion tools, the power source 14 is powered by internal combustion and includes a combustion chamber 18 that communicates with a cylinder 20. A piston 22 reciprocally disposed within the cylinder 20 is connected to the upper end of a driver blade 24. As shown in FIG. 1, an upper limit of the reciprocal travel of the piston 22 is referred to as a pre-firing position, which occurs just prior to firing, or the ignition of the combustion gases, which initiates the downward driving of the driver blade 24 to impact a fastener (not shown) to drive it into a workpiece.

At the prefiring position, the piston 22 defines a lower end of the combustion chamber 18. Opposite the piston 22, a cylinder head 26 defines an upper end of the combustion chamber 18. Sides of the combustion chamber 18 are defined by a generally tubular valve sleeve 28 which reciprocates relative to the cylinder 20 and the cylinder head 26 between an open position (not shown) and a closed or pre-firing position (FIG. 1) as is well known in the art. A fan 30 and an associated motor 32 project into the combustion chamber 18 as disclosed in the patents referred to above. At least one exhaust valve 34 is disposed in the cylinder 20 at a lower end thereof for permitting spent exhaust gases to exit the cylinder.

The present seal, generally designated 40, is contemplated as being disposed on at least one tool component including, but not limited to the piston 22, the cylinder 20 at an upper end 42 thereof (shown at 40a), and on the cylinder head 26 where an upper end 44 of the valve sleeve 28 rests in the closed chamber position depicted in FIG. 1 (shown at 40b). However, for purposes of explanation, the seal 40 will be described in its orientation on the piston 22.

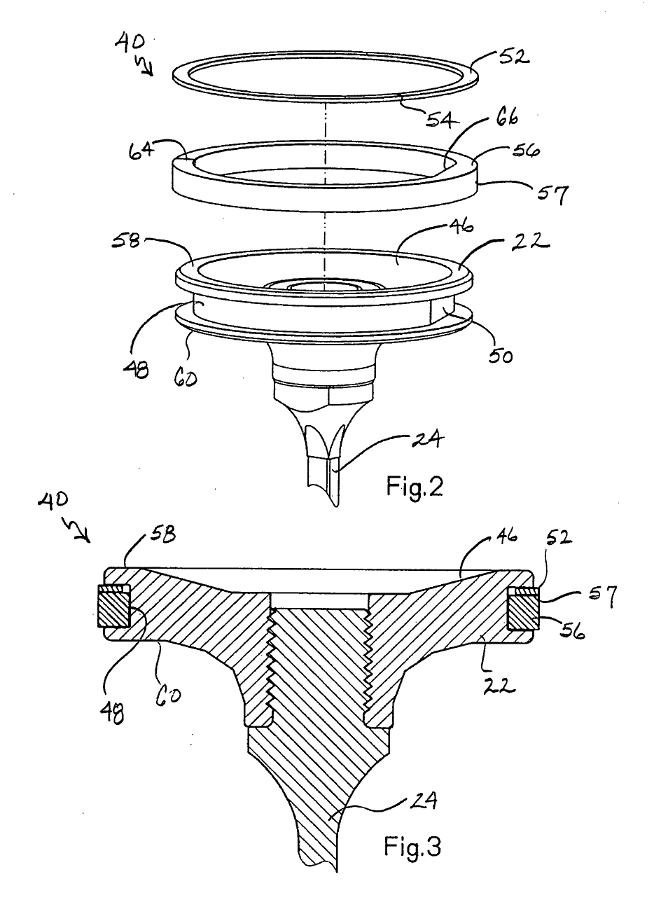

Referring now to FIGS. 2 and 3, the piston 22 includes a component body 46 defining at least one laterally recessed seal groove 48. As is known in the art, the dimensions of the groove 48 are dictated, among other factors, by the material used for the piston 22, and the power rating of the tool 10. The groove 48 should not have a height relative to the component body 46 of the piston 22 which would structurally weaken the piston. In the preferred embodiment, the at least one seal groove 48 is keyed or provided with at least one body key formation 50 shown here as a flat spot on an otherwise annular configuration. It is preferred that the piston 22 is oriented in the cylinder 20 so that the exhaust valve 34, the body key formation 50 and the driver blade 24 are in desired relative positions.

A metallic ring 52 is disposed in the at least one seal groove 48 and is contemplated as being a conventional piston ring with a joint or gap 54. The ring 52 is preferably made of steel or other material having low thermal expansion. As such, the joint 54 can be relatively small which prevents or minimizes gas leakage or blow-by. While typical piston rings require lubrication, in the present seal 40, a companion polymeric ring 56 provides adequate lubrication. The polymeric ring 56 is made at least in part of a polymer containing filler materials having self-lubricating properties and good wear characteristics against materials of interest such as steel or aluminum. Such filler materials include but are not limited to PTFE (Teflon® brand material), graphite and molybdenum disulfide. The polymeric ring 56 is disposed in the at least one seal groove 48 in operational relationship to the metallic ring 52. It has been found that the use of the metallic ring 52 adjacent to or in the vicinity of the polymeric ring 56 promotes and extends the operational life of the seal 40. It is preferred that the polymeric ring have an outer peripheral edge 57 which is generally vertical or parallel to the direction of motion of the component body 46 relative to the adjacent surface, such as the cylinder 20. Also, the edge 57 preferably projects radially approximately as far as the metallic ring 52, however other relative relationships are contemplated.

Lubrication deposits transferred by the polymeric ring 56 on the cylinder 20 and other surfaces enables the metallic ring 52 to function directly without supplemental lubricants. Accordingly, one purpose of the polymeric ring 56 is as a wear band for preventing wear between sliding surfaces.

In the preferred embodiment, the component body 46 has a combustion end 58 and an opposite end 60 which is displaced from the combustion end and as such is shielded from the heat and corrosion inherent with the combustion event. The metallic ring 52 is preferably disposed adjacent the polymeric ring 56 closer to the combustion end 58 for better sealing results. However, it is also contemplated that the metallic ring 52 is alternately located closer to the opposite end 60, depending on the application.

Another advantage of the present seal 40 is that the metallic ring 52 functions as a scraper for removing deposits off of the surfaces (such as the cylinder 20) upon which the sliding component (such as the piston 22) reciprocates. Such scraping action extends the working life of the seal 40 and extends tool use between maintenance sessions. The metallic ring 52 can perform the scraping action regardless of the direction of sliding movement.

It will be seen from FIGS. 2 and 3 that both the metallic ring 52 and the polymeric ring 56 are located in the same groove 48. While this is the preferred orientation, it is not contemplated as being exclusive, as will be described below.

To reduce exhaust gas blow-by and consequential corrosion of the polymeric ring 56, the at least one seal groove 48 is keyed in the form of the body key formation 50 such as a flat spot. As described above, the formation 50 is disposed in an adjacent orientation relative to the exhaust valve 34. Thus, when a joint or gap 64 in the polymeric ring 56 defined or formed by opposing ends is diametrically opposed to a ring key formation 66 which matingly engages the body key formation 50 upon installation, the gap 64 will be consistently located out of engagement, and free of contact with the exhaust valve 34. This location will reduce the chances of the gap 66 experiencing exhaust blow-by or physical deterioration through contact with the exhaust valve 34. However, other locations in the groove 48 for the body key formation 50 are contemplated.

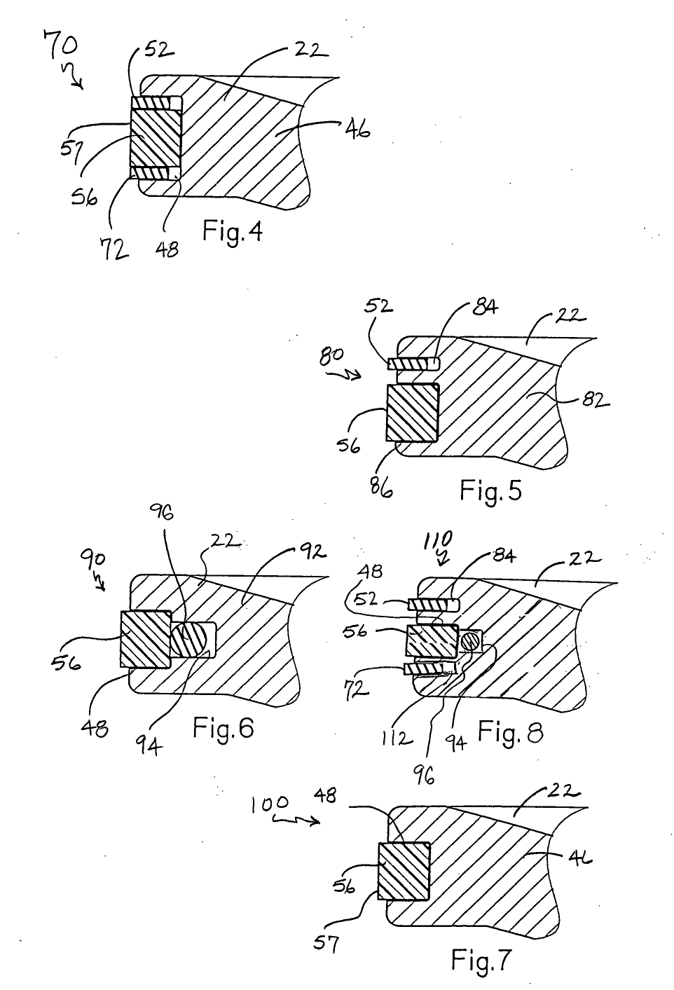

Referring now to FIG. 4, an alternate embodiment of the present seal is generally designated 70. Shared components between the seals 40 and 70 are designated with the same reference numbers. A distinctive feature of the seal 70 is that a second metallic ring 72 is disposed opposite the first metallic ring 52 with the polymeric ring 56 sandwiched therebetween. It will be seen that all three rings, 52, 56 and 72 are located in the same groove 48. However, it is contemplated that the rings 52, 56 and 72 can be located in separate grooves, but the use of a single groove reduces space requirements.

Referring now to FIG. 5, another alternate embodiment is generally designated 80. Shared components among the seals 40 and 70 are designated with the same reference numbers. A distinctive feature of the seal 80 is that a component body 82 is provided having two grooves, a first groove 84 for the metal ring 52 and a second groove 86 for the polymeric ring 56. The grooves 84, 86 are vertically spaced from each other, with the first groove 84 located closer to the combustion end 58. It will be understood that the disposition of the two grooves 84, 86 may be reversed depending on the application.

Referring now to FIG. 6, yet another alternate embodiment is generally designated 90. Shared components among the seals 40, 70 and 80 are designated with the same reference numbers. A main feature of the embodiment 90 is that the polymeric ring 56 is provided without a metallic ring 52. In this embodiment, the seal groove 48 is keyed with the body key formation 50, and the ring 56 is also provided with the ring key formation 66 as described in FIG. 2. Since the seal 90 lacks the metallic ring 52, it is contemplated that in some applications the polymeric ring 56 will experience more rapid wear. To promote the lubricating properties of the single ring 56 and its ability to seal, the component body 92 is provided with a supplemental seal groove 94 having a smaller diameter than, and preferably in communication with, the seal groove 48.

In some applications a supplemental energizing ring 96 is provided to exert a radial outwardly directed biasing force on the polymeric ring 56. Preferably, the supplemental energizing ring 96 is concentric in either the groove 48 or the supplemental seal groove 94 relative to the polymeric ring 56. While the polymeric ring 56 is generally square or rectangular in cross-section, the supplemental energizing ring 96 is preferably circular in cross-section. It is also contemplated that the supplemental energizing ring 96 will have a smaller diameter than the polymeric ring 56. It is preferred that the supplemental energizing ring 96 be made of elastomeric material.

Referring now to FIG. 7, an alternate embodiment to the seal disclosed in FIG. 6 is generally designated 100. Shared components among the seals 40, 70, 80 and 90 are designated with the same reference numbers. A main feature of the embodiment 100 is that, like the seal 90, it lacks a metallic ring 52. Instead, only the polymeric ring 56 is present in the seal groove 48. In addition, the seal groove 48 is configured for only accommodating the polymeric ring 56, and is not provided with a supplemental seal groove 94 or a supplemental polymeric ring 96.

Referring now to FIG. 8, an alternative to the seal disclosed in FIG. 4 is generally designated 110. Shared components with the seals 40, 70, 80 and 90 are designated with the same reference numbers. A main feature of the embodiment 110 is that each of the rings 52, 56 and 72 is provided with a corresponding groove, 84, 48 and 112. In addition, a supplemental seal groove 94 and a supplemental energizing ring 96 may be optionally provided depending on the application.

Thus, it will be appreciated that with the present seal 40 and its alternate embodiments, the associated tool 10 will require less maintenance since supplemental lubricant is not required to reduce friction. The combination of the metallic ring 52 with the polymeric ring 56 protects the polymeric ring from wear and corrosive forces of combustion, and the polymeric ring provides the lubricant for the metallic ring and prevents wear from contact between components undergoing relative motion. The key feature reduces the corrosion and exhaust blow-by experienced by prior art polymeric seal rings, as well as physical joint wear caused by contact with the exhaust ports.

While specific embodiments of the seal for a fastener-driving tool of the present invention have been shown and described, it will be appreciated by those skilled in the art that changes and modifications may be made thereto without departing from the invention in its broader aspects and as set forth in the following claims.

1. A seal for use in a fastener-driving tool on a component moving relative to another component, comprising:
a component body defining at least one seal groove;
a metallic ring disposed in said at least one seal groove; and
a polymeric ring disposed in said at least one seal groove in operational relationship to said metallic ring;
wherein said at least one seal groove is keyed, and said polymeric ring is provided with a key formation for engagement in a desired position in said at least one groove upon installation.

2. The seal of claim 1 wherein said component body has a combustion end and an opposite end, said metallic ring being disposed on said combustion end.

3. (canceled)

4. The seal of claim 1 wherein the tool has an exhaust port and said polymeric ring has a joint formed by opposing ends, said key formation being disposed on said polymeric ring such that said joint is disposed in avoidance of the exhaust port.

5. The seal of claim 1 wherein said polymeric ring includes at least one of a self-lubricating material taken from the group consisting of PTFE, graphite and molybdenum disulfide.

6. The seal of claim 1 wherein said body has a first seal groove and a second seal groove, said metallic ring being disposed in one of said first and second seal grooves, said polymeric ring being disposed in the other of said first and second seal grooves.

7. The seal of claim 1 further including a second metallic ring disposed in said at least one seal groove.

8. The seal of claim 7 wherein said at least one groove is a single groove and said first and second metallic rings are disposed in said groove with said polymeric ring disposed therebetween.

9. The seal of claim 1 further including a second metallic ring and wherein said at least one groove is three grooves, each groove associated with one of said rings.

10. The seal of claim 1 further including a supplemental energizing ring concentric in said at least one groove with said polymeric ring.

11. The seal of claim 10 wherein said supplemental energizing ring is made of elastomeric material.

12. The seal of claim 10 wherein said supplemental energizing ring has a diameter less than a diameter of said polymeric ring.

13. The seal of claim 10 further including a supplemental groove configured for accommodating said supplemental energizing ring.

14. The seal of claim 1 wherein said component body is disposed on at least one of a piston, a cylinder and a cylinder head.

15. A seal for use in a fastener-driving tool with at least one exhaust valve on a component moving relative to another component, comprising:
a component body defining at least one seal groove having a body key formation disposed in an adjacent orientation relative to the at least one exhaust valve;
a polymeric ring having a joint, being separately formed from said component body, and configured for disposition in said at least one seal groove and having a ring key formation diametrically opposed to said joint and configured for engaging said body key formation, such that upon installation in said at least one groove, said joint is free of operational contact with the at least one exhaust valve.

16. The seal of claim 15 further including at least one metallic ring disposed in said at least one seal groove in operational relationship to said polymeric ring.

17. The seal of claim 16 further including a supplemental energizing ring concentric in said at least one groove with said polymeric ring.

18. The seal of claim 15 further including a supplemental energizing ring concentric in said at least one groove with said polymeric ring.

19. The seal of claim 18 wherein said supplemental energizing ring is made of elastomeric material.

20. The seal of claim 18 wherein said supplemental energizing ring has a diameter less than a diameter of said polymeric ring.

21. The seal of claim 18 further including a supplemental groove configured for accommodating said supplemental energizing ring.

22. The seal of claim 1 wherein said metallic ring has a smaller thickness and height than said polymeric ring.

23. A seal for use in a fastener-driving tool on a component moving relative to another component, comprising:
a component body defining a first seal groove and a second seal groove separately disposed from said first seal groove;
a metallic ring disposed in said first seal groove; and
a polymeric ring disposed in said second seal groove.

24. The seal of claim 23 wherein said metallic ring has a smaller thickness and height than said polymeric ring, and wherein said first and second seal grooves are sized to accommodate said metallic and polymeric rings, respectively.
